(19) United States
(12) Patent Application Publication
(10) Pub. No.: US 2015/0128574 A1
(43) Pub. Date: May 14, 2015

(54) AIR-FUEL RATIO CONTROL DEVICE OF INTERNAL COMBUSTION ENGINE

(71) Applicants: Go Hayashita, Ebina-shi (JP); Keiichiro Aoki, Suntou-gun (JP)

(72) Inventors: Go Hayashita, Ebina-shi (JP); Keiichiro Aoki, Suntou-gun (JP)

(73) Assignee: TOYOTA JIDOSHA KABUSHIKI KAISHA, Toyota-shi, Aichi-ken (JP)

(21) Appl. No.: 14/400,870

(22) PCT Filed: May 23, 2012
(86) PCT No.: PCT/JP2012/063203

§ 371 Date: Nov. 13, 2014

(51) Int. Cl. F01N 3/20; F02D 35/00

(52) U.S. Cl. CPC F01N 3/2006; F02D 35/0007; F02D 35/0015
USPC 60/285

(57) ABSTRACT

This invention relates to an air-fuel ratio control device of an internal combustion engine, and an object of the invention is to provide an air-fuel ratio control device of an internal combustion engine that is capable of suppressing a deterioration in the controllability of air-fuel ratio feedback control after restarting an engine. FIG. 6 illustrates an elapsed time after engine startup, and output values of a front A/F sensor 16 and a rear A/F sensor 18. As shown in FIG. 6, the output values of the front A/F sensor 16 and rear A/F sensor 18 become equal from a time T3 onwards. Hence, by switching to normal air-fuel ratio feedback control at the time T3, highly accurate air-fuel ratio feedback control that is in accordance with the actual situation is enabled.

### TECHNICAL FIELD

The present invention relates to an air-fuel ratio control device of an internal combustion engine, and more particularly to an air-fuel ratio control device of an internal combustion engine in which air-fuel ratio sensors are provided upstream and downstream of a catalyst that is provided in an exhaust passage.

### BACKGROUND ART

An internal combustion engine in which sensors having an air-fuel ratio detection function are provided upstream and downstream of a catalyst provided in an exhaust passage is already known. Various devices that perform failure detection and the like with respect to the catalyst using the outputs of the sensors are also known.

For example, Patent Literature 1 discloses a failure detection device for an air-fuel ratio control device in which two air-fuel ratio sensors are provided upstream and downstream of a catalyst. This failure detection device is designed on the premise of performing air-fuel ratio feedback control using the output of the air-fuel ratio sensor on the upstream side of the catalyst, and detection of a failure (or deterioration) of the two air-fuel ratio sensors or the catalyst is performed based on a difference between the outputs of the sensors on the upstream and downstream sides of the catalyst.

Further, for example, Patent Literature 2 discloses an air-fuel ratio control device in which an air-fuel ratio sensor is provided upstream of a catalyst, and an oxygen sensor is provided downstream of the catalyst. Similarly to the device disclosed in the aforementioned Patent Literature 1, this air-fuel ratio control device is designed on the premise of performing air-fuel ratio feedback control using the output of the air-fuel ratio sensor on the upstream side of the catalyst. However, in this air-fuel ratio control device, during a period until the air-fuel ratio sensor activates, the output of the oxygen sensor is substituted for the output of the air-fuel ratio sensor. The reason is that there is a difference in the sensor structure between the air-fuel ratio sensor and the oxygen sensor, and consequently the activation temperature of the air-fuel ratio sensor is higher than that of the oxygen sensor and a long time period is required for activation of the air-fuel ratio sensor. That is, in view of the difference between the activation characteristics of the two kinds of sensors, this air-fuel ratio control device performs air-fuel ratio feedback control that temporarily makes use of the oxygen sensor that activates at a relatively low temperature.

Further, for example, Patent Literature 3 discloses a catalyst deterioration detection device in which, similarly to Patent Literature 2, two kinds of sensors are mounted, and which performs deterioration detection with respect to a catalyst, similarly to Patent Literature 1. In this catalyst deterioration detection device, upon establishment of a permission condition that the state is after a predetermined operation that makes an air-fuel ratio upstream of the catalyst a lean ratio, the deterioration detection is performed immediately after engine start-up. The reason is that rich components contained in exhaust gas (also referred to as “unburned gas components”; the same applies hereunder) immediately after engine start-up are liable to adhere to a sensor, and furthermore, the adhered rich components can be removed by supplying lean gas. That is, this catalyst deterioration detection device is a device that, in consideration of the exhaust characteristics immediately after engine start-up, performs deterioration detection with respect to a catalyst after rich components that adhered to a sensor were removed by lean gas.

Furthermore, for example, in Patent Literature 4, an air-fuel ratio control device is disclosed in which an oxygen sensor is provided downstream of a catalyst and which performs air-fuel ratio feedback control using the output of the oxygen sensor.

### CITATION LIST

### Patent Literature

### Patent Literature 1

Japanese Patent Laid-Open No. 6-280662

### Patent Literature 2

Japanese Patent Laid-Open No. 8-261042

### Patent Literature 3

Japanese Patent Laid-Open No. 2008-121465

### Patent Literature 4

Japanese Patent Laid-Open No. 4-342848

### SUMMARY OF INVENTION

A sensor adherence period of rich components contained in exhaust gas that is mentioned in Patent Literature 3 is not limited to immediately after engine start-up. For example, after an engine stops, exhaust gas which contains concentrated rich components stagnate in the exhaust passage on the upstream side of the catalyst. Consequently, after the engine stops, there is a possibility that the rich components will adhere to the air-fuel ratio sensor on the upstream side of the catalyst. In particular, in a case where a porous layer is used for a sensor element, the adherence of rich components to the inner part of the pores is unavoidable.

The rich components that are adhered to the air-fuel ratio sensor can be detached by raising the exhaust gas temperature after restarting the engine. If the rich components can be detached, the sensor accuracy of the air-fuel ratio sensor will be restored. However, the atmosphere in the area surrounding the sensor becomes a rich atmosphere while the rich components are being detached. Consequently, during that period, the air-fuel ratio sensor indicates an output that is on the rich side relative to the actual air-fuel ratio. Accordingly, in the case of performing air-fuel ratio feedback control using the output of the air-fuel ratio sensor on the upstream side, there has been the possibility that the controllability thereof will deteriorate while the rich components are being detached.

The present invention has been conceived in view of the above described problem. That is, an object of the present invention is to provide an air-fuel ratio control device of an internal combustion engine that is capable of suppressing a deterioration in the controllability of air-fuel ratio feedback control after restarting an engine.

### Means for Solving the Problem

To achieve the above described object, a first invention is an air-fuel ratio control device of an internal combustion engine, comprising:

an exhaust purification catalyst that is provided in an exhaust passage of the internal combustion engine;

an upstream-side air-fuel ratio sensor that is provided in the exhaust passage on an upstream side relative to the exhaust purification catalyst, and that continuously outputs a signal that is in accordance with an air-fuel ratio;

a downstream-side air-fuel ratio sensor that is provided in the exhaust passage on a downstream side relative to the exhaust purification catalyst, and that continuously outputs a signal that is in accordance with an air-fuel ratio;

usage permission condition determination means for, at a time of starting the internal combustion engine, after the upstream-side air-fuel ratio sensor and the downstream-side air-fuel ratio sensor are both activated, determining whether or not a predetermined usage permission condition is established with respect to an output of the upstream-side air-fuel ratio sensor; and

startup time air-fuel ratio feedback control execution means for executing air-fuel ratio feedback control using an output of the downstream-side air-fuel ratio sensor until the predetermined usage permission condition is established.

A second invention is the air-fuel ratio control device of an internal combustion engine according to the first invention, wherein main air-fuel ratio feedback control using the output of the upstream-side air-fuel ratio sensor, and sub-air-fuel ratio feedback control using the output of the downstream-side air-fuel ratio sensor is executed after the predetermined usage permission condition is established.

A third invention is the air-fuel ratio control device of an internal combustion engine according to the first or the second invention, wherein the predetermined usage permission condition is whether or not an output difference between the output of the upstream-side air-fuel ratio sensor and the output of the downstream-side air-fuel ratio sensor is less than a predetermined deviation over a set period.

A fourth invention is the air-fuel ratio control device of an internal combustion engine according to the first or the second invention, wherein the predetermined usage permission condition is whether or not a set period elapses.

A fifth invention is the air-fuel ratio control device of an internal combustion engine according to the any one of the first to the fourth inventions, wherein the startup time air-fuel ratio feedback control execution means prohibits execution of air-fuel ratio feedback control using the output of the upstream-side air-fuel ratio sensor until the predetermined usage permission condition is established.

### Advantageous Effects of Invention

According to the first invention, after both an upstream-side air-fuel ratio sensor and a downstream-side air-fuel ratio sensor are activated, air-fuel ratio feedback control using the output of the downstream-side air-fuel ratio sensor can be executed until a predetermined usage permission condition is established. As described above, exhaust gas that includes rich components stagnates in the exhaust passage after the engine stops. Consequently, the upstream-side air-fuel ratio sensor is affected by the adherence of rich components. However, on the downstream side of the exhaust purification catalyst, the concentration of rich components is low, and therefore the influence that the adherence of rich components has on the downstream-side air-fuel ratio sensor is low. Accordingly, after both the upstream-side air-fuel ratio sensor and the downstream-side air-fuel ratio sensor are activated, if the output of the downstream-side air-fuel ratio sensor is used until a predetermined usage permission condition is established, a deterioration in the controllability of the air-fuel ratio feedback control after restarting can be suppressed. Further, it is possible to improve emissions performance at the time of restarting the engine.

According to the second invention, after the above described predetermined usage permission condition is established, since main air-fuel ratio feedback control that uses the output of the aforementioned upstream-side air-fuel ratio sensor and sub-air-fuel ratio feedback control that uses the output of the aforementioned downstream-side air-fuel ratio sensor can be executed, it is possible to improve emissions performance after restarting.

According to the third invention, the aforementioned predetermined usage permission condition can be determined based on whether or not the aforementioned output difference is less than a predetermined deviation over a set period. The upstream-side air-fuel ratio sensor and the downstream-side air-fuel ratio sensor are sensors that have similar output properties. Consequently, monitoring of the aforementioned output difference is simple. Therefore, according to the third invention, completion of the detachment of rich components from the upstream-side air-fuel ratio sensor can be determined by a simple technique,

According to the fourth invention, the aforementioned predetermined usage permission condition can be determined based on whether or not the aforementioned set period elapsed. Therefore, according to the fourth invention, similarly to the third invention, completion of the detachment of rich components from the upstream-side air-fuel ratio sensor can be determined by a simple technique.

According to the fifth invention, since execution of air-fuel ratio feedback control using the output of the upstream-side air-fuel ratio sensor is prohibited until the predetermined usage permission condition is established, a deterioration in the controllability of the air-fuel ratio feedback control after restarting can be reliably suppressed.

### BRIEF DESCRIPTION OF DRAWINGS

FIG. 1 is a view that illustrates the system configuration of an air-fuel ratio control device according to Embodiment 1.

FIG. 2 is a view that illustrates a relation between elapsed time after engine startup and the air-fuel ratio.

FIG. 3 is an enlarged schematic view of a sensor element portion of the A/F sensor.

FIG. 4 is an enlarged view of a portion A in FIG. 3.

FIG. 5 is a flowchart illustrating an air-fuel ratio feedback control routine that is executed by the ECU 20 in Embodiment 1.

FIG. 6 illustrates an elapsed time after engine startup, and output values of the front A/F sensor 16 and rear A/F sensor 18.

FIG. 7 is a flowchart illustrating an air-fuel ratio feedback control routine that is executed by the ECU 20 in Embodiment 2.

### DESCRIPTION OF EMBODIMENTS

### Embodiment 1

### Description of System Configuration

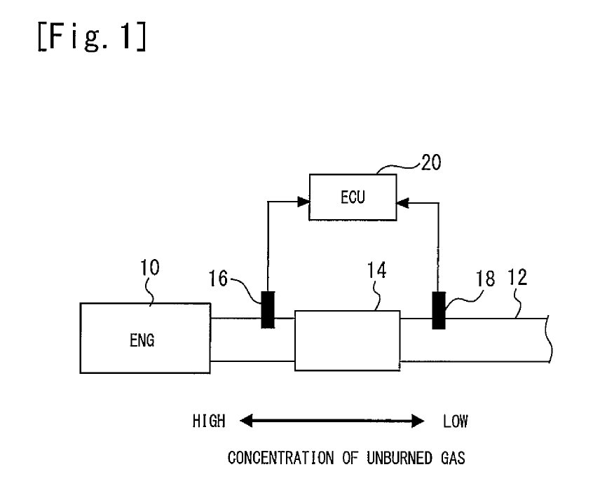

First, Embodiment 1 of the present invention will be described while referring to FIG. 1 to FIG. 5. FIG. 1 is a view that illustrates the system configuration of an air-fuel ratio control device according to Embodiment 1. As shown in FIG. 1, the system of the present embodiment includes an engine 10 as a motive power apparatus for a vehicle. A catalyst 14 is arranged in an exhaust passage 12 of the engine 10. The catalyst 14 is a three-way catalyst that efficiently purifies the three components HC, CO, and NOx that are contained in exhaust gas when an air-fuel ratio of exhaust gas that flows into the catalyst is in a narrow range in the vicinity of stoichiometry.

As shown in FIG. 1, a front A/F sensor 16 is arranged on an upstream side of the catalyst 14. Similarly, a rear A/F sensor 18 is arranged on a downstream side of the catalyst 14. The front A/F sensor 16 and the rear A/F sensor 18 are constituted by linear detection-type sensors that are capable of continuously detecting an air-fuel ratio over a relatively wide range, and output signals proportional to an air-fuel ratio of exhaust gas that flows into the catalyst 14 and an air-fuel ratio of exhaust gas that passed through the catalyst 14.

The system of the present embodiment also includes an ECU (Electronic Control Unit) 20. The aforementioned front A/F sensor 16 and rear A/F sensor 18 as well as various other sensors that are required for control of the vehicle and the engine 10 are connected to an input side of the ECU 20. On the other hand, various actuators such as an injector (not shown in the drawings) that injects fuel into the engine 10 are connected to an output side of the ECU 20. The ECU 20 executes various kinds of control such as air-fuel ratio feedback control that is described hereunder using the output of the front A/F sensor 16 and the rear A/F sensor 18.

### [Air-Fuel Ratio Feedback Control]

Air-fuel ratio feedback control is one kind of engine control that the ECU 20 performs. According to the air-fuel ratio feedback control, A/F feedback control that is based on the output value of the front A/F sensor 16 (main A/F feedback control), and A/F feedback control that is based on the output value of the rear A/F sensor 18 (sub-A/F feedback control) are performed. In the main A/F feedback control, a main FB value in which the calculation of a fuel injection amount (calculated based on the intake air amount and the number of engine revolutions) is reflected is calculated based on a deviation between an output value of the front A/F sensor 16 and the theoretical air-fuel ratio. In the sub-A/F feedback control, a deviation between an output value of the rear A/F sensor 18 and a reference value that corresponds to an optimal catalyst purification point is determined, and a sub-F/B value is calculated in which the aforementioned fuel injection amount is reflected by PID control with respect to the deviation.

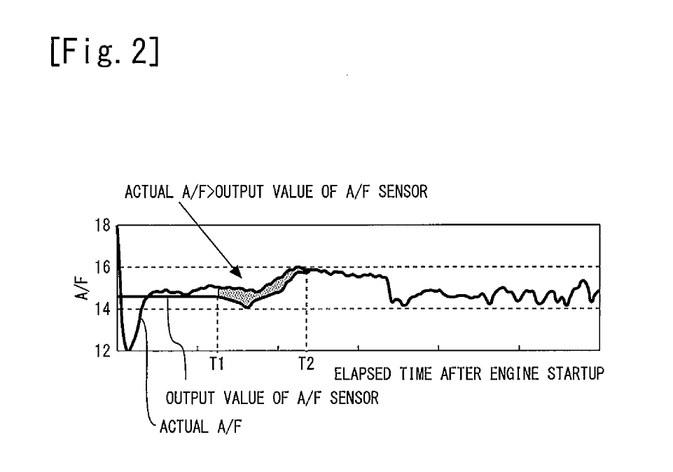

In this connection, as described above, after an engine stops, exhaust gas containing concentrated rich components stagnates in an exhaust passage on an upstream side of a catalyst. This stagnation phenomenon also arises in the present system. Therefore, after the engine 10 stops, there is a possibility that rich components contained in the exhaust gas will adhere to the front A/F sensor 16 or the rear A/F sensor 18. This situation will now be described referring to FIG. 2. FIG. 2 is a view that illustrates a relation between elapsed time after engine startup and the air-fuel ratio. Note that the air-fuel ratio shown in FIG. 2 is a ratio measured on the upstream side of the catalyst (that is, the vicinity of the front A/F sensor 16).

As shown in FIG. 2, after the sensor is activated at a time T₁, until a time T₂, a divergence arises between the actual air-fuel ratio (actual A/F) and the output value of the A/F sensor (a so-called “rich output deviation” occurs). This happens because rich components contained in exhaust gas have adhered to an element portion of the A/F sensor.

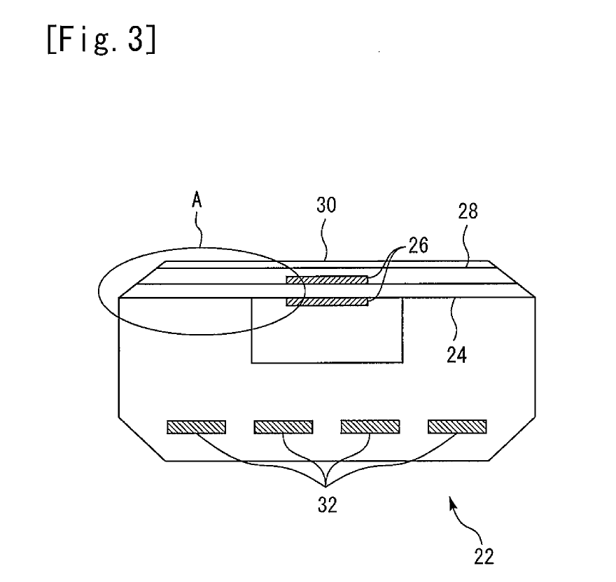

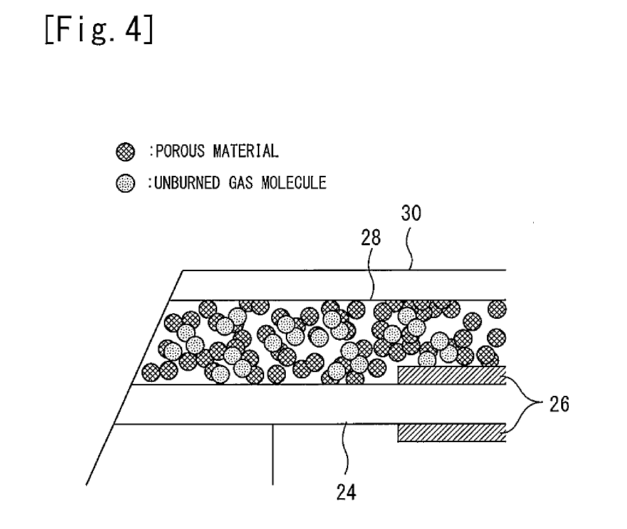

Next, adherence of rich components to the element portion of the A/F sensor will be described referring to FIG. 3 and FIG. 4. FIG. 3 is an enlarged schematic view of a sensor element portion of the A/F sensor. Note that the structure of the sensor element portion 22 shown in the present drawing is common to the front A/F sensor 16 and the rear A/F sensor 18.

As shown in FIG. 3, the sensor element portion 22 includes a solid electrolyte 24, a pair of electrodes 26, a diffusion-controlling layer 28, a shielding layer 30 and a heater 32. The solid electrolyte 24 is composed of, for example, a material containing a mixture of zirconia and yttria, and is formed in a substantially tabular shape. The electrodes 26 are composed, for example, of Pt, and, similarly to the solid electrolyte 24, are formed in a substantially tabular shape. The diffusion-controlling layer 28 is a porous layer for which, for example, alumina particles are used as the material, and is a layer that distributes gas. On the other hand, the shielding layer 30 is a dense layer for which, for example, alumina is used as the material, and is a layer that blocks gas.

FIG. 4 is an enlarged view of a portion A in FIG. 3. As described above referring to FIG. 3, alumina particles are used as the material of the diffusion-controlling layer 28. After the engine stops, rich components liquefy and adsorb on the alumina particles when the temperature in the exhaust passage 12 drops. FIG. 3 is a view that illustrates a state in which rich components are adsorbed on the alumina particles. The adsorbed rich components are desorbed by an increase in the temperature of the sensor element portion 22. That is, the rich components are desorbed by an increase in the exhaust gas temperature after the engine 10 restarts. However, while the rich components are being desorbed, the area around the sensor element portion 22 becomes a rich atmosphere due to the desorbed components. Accordingly, during that period (that is, a period from the time T1 to the time T2 in FIG. 2), the output value of the A/F sensor indicates an output that is on the rich side relative to the actual A/F.

However, as shown in FIG. 1, the concentration of unburned gas components is high on the upstream side of the catalyst 14 and becomes progressively lower towards the downstream side. The reason is that the unburned gas components are absorbed by the catalyst 14. That is, there are almost no unburned gas components on the downstream side of the catalyst 14, and it can be said that the possibility of the above described divergence occurring at the rear A/F sensor 18 is small. Therefore, in the present embodiment a configuration is adopted in which air-fuel ratio feedback control is executed without using the output value of the front A/F sensor 16 until a fixed period elapses after activation of the front A/F sensor 16 and the rear A/F sensor 18.

Specifically, in the present embodiment, until the aforementioned fixed period elapses, calculation of the main F/B value by the front A/F sensor 16 is stopped, and only calculation of the sub-F/B value by the rear AJF sensor 18 is performed. That is, during this period, only the sub-F/B value that is calculated based on the output of the rear A/F sensor 18 is reflected in the aforementioned fuel injection amount. However, a correction amount of air-fuel ratio feedback that uses only the sub-F/B value is small, and it is difficult for the correction to be effective. Therefore, in the sub-A/F feedback control during this period, a feedback gain (PID control coefficient) is set larger than at a normal time (for example, is doubled).

### [Specific Processing in Embodiment 1]

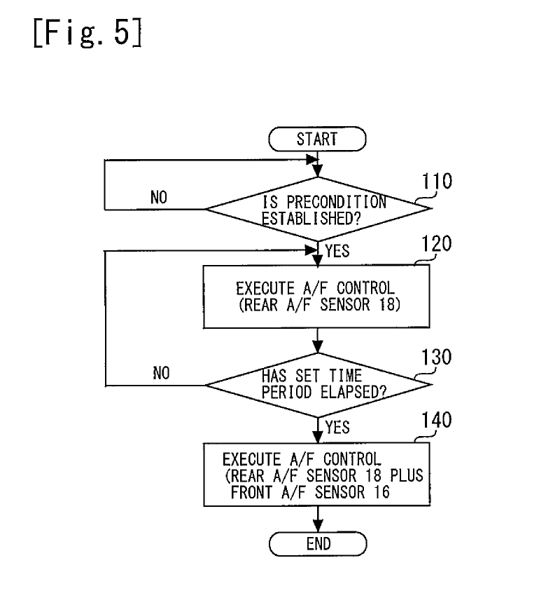

Next, specific processing of the above described air-fuel ratio feedback control will be described referring to FIG. 5. FIG. 5 is a flowchart illustrating an air-fuel ratio feedback control routine that is executed by the ECU 20 in Embodiment 1. Note that, it is assumed that the routine illustrated in FIG. 5 is repeatedly executed at regular intervals.

In the routine illustrated in FIG. 5, first, the ECU 20 determines whether or not a precondition is established (step 110). The precondition is established when (i) there was a start-up request with respect to the engine 10, and (ii) the front A/F sensor 16 and the rear A/F sensor 18 have been activated (warming up of the sensors is completed). If it is determined that the precondition is established, the ECU 20 calculates the aforementioned sub-FIB value using the output value of the rear A/F sensor 18, and controls the fuel injection amount (step 120). That is, only sub-feedback control using the output value of the rear A/F sensor 18 is executed. If it is determined that the precondition is not established, the ECU 20 returns to step 110 to again determine whether or not the precondition is established.

After step 120, the ECU 20 determines whether or not a set time period has elapsed (step 130). In the present step, the set time period is a time period that corresponds to the above described fixed period, and a compatible value that is separately stored in advance in the ECU 20 is used as the set time period. The processing of the present step is continued until the set time period elapses after establishment of the aforementioned precondition. When it is determined that the set time period has elapsed, the ECU 20 executes normal air-fuel ratio feedback control (step 140). That is, the ECU 20 calculates the aforementioned main F/B value using the output value of the front A/F sensor 16 and also calculates the aforementioned sub-F/B value using the output value of the rear A/F sensor 18, and controls the fuel injection amount. That is, main feedback control using the output value of the front A/F sensor 16, and sub-feedback control using the output value of the rear A/F sensor 18 are executed.

Thus, according to the routine illustrated in FIG. 5, after establishment of the precondition, only sub-feedback control using the output value of the rear A/F sensor 18 is executed until a set time period elapses. Since the influence of adherence of rich component on the rear A/F sensor 18 is small in comparison to the front A/F sensor 16, there is almost no rich output deviation. Accordingly, a deterioration in the controllability of the air-fuel ratio feedback control immediately after engine start-up can be suppressed, and it is possible to improve the emissions performance when starting the engine.

In this connection, in the above described Embodiment 1, although calculation of the main F/B value by the front A/F sensor 16 is stopped until the fixed period elapses, a configuration may also be adopted in which the calculation of the main F/B value itself is not stopped. That is, the aforementioned main F/B value may be estimated by substituting the output value of the rear A/F sensor 18 for the output value of the front A/F sensor 16. As long as the output of the front A/F sensor 16 is not used until the aforementioned fixed period elapses, at least the same effects as those of the above described Embodiment 1 can be obtained. Accordingly, various modifications are possible with respect to the above described Embodiment 1 as long as air-fuel ratio feedback control that is based on the output of the rear A/F sensor 18 and that does not use the output value of the front A/F sensor 16 is executed until the aforementioned fixed period elapses.

Note that, in the above described Embodiment 1, the catalyst 14 corresponds to “catalyst” in the above described first invention, the front A/F sensor 16 corresponds to “upstream-side air-fuel ratio sensor” in the first invention, and the rear A/F sensor 18 corresponds to “downstream-side air-fuel ratio sensor” in the first invention.

Further, “usage permission condition determination means” in the above described first invention is realized by the ECU 20 executing the processing in step 130 in FIG. 5, and “startup time air-fuel ratio feedback control execution means” is realized by the ECU 20 executing the processing in step 120 in FIG. 5.

### Embodiment 2

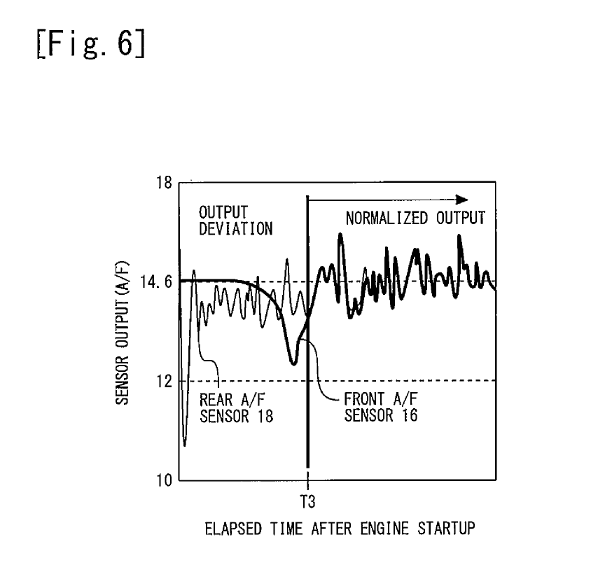

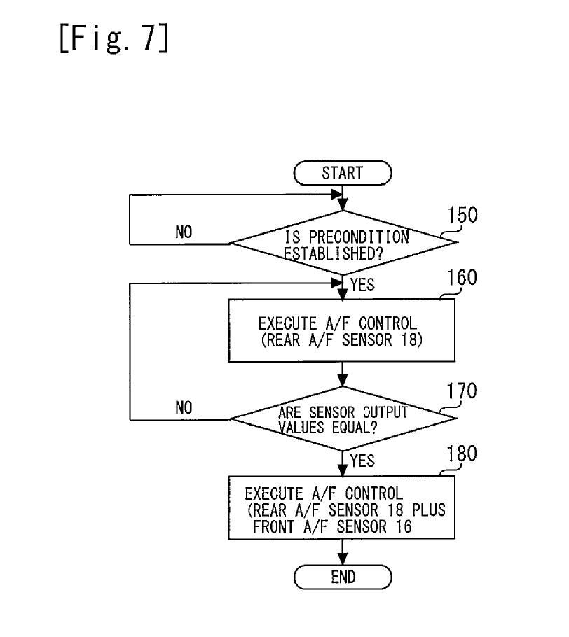

Next, Embodiment 2 of the present invention will be described referring to FIG. 6 and FIG. 7. A feature of the present embodiment is that an air-fuel ratio feedback control routine that is illustrated in FIG. 7 is executed with respect to the apparatus configuration shown in FIG. 1. Consequently, a description of the apparatus configuration is omitted hereunder.

### [Air-Fuel Ratio Feedback Control in Embodiment 2]

In the air-fuel ratio feedback control of Embodiment 1 that is described above, a compatible value is used for the set time period. However, a rich output deviation also varies according to the adhered amount of rich components. Therefore, there is a high possibility that a time period until the output value of the front A/F sensor 16 returns to normal will depend on an operating history condition prior to restating the engine. As described above, the influence of the adherence of rich components on the rear A/F sensor 18 is small. That is, the output value of the rear A/F sensor 18 indicates a normal value from the time after restarting the engine. The air-fuel ratio feedback control of the present embodiment focuses attention on this fact, and is configured to determine that the influence of a rich output deviation has disappeared at a time point at which the output value of the front A/F sensor 16 and the output value of the rear A/F sensor 18 become equal.

FIG. 6 illustrates an elapsed time after engine startup, and output values of the front A/F sensor 16 and rear A/F sensor 18. As shown in FIG. 6, the output values of the front A/F sensor 16 and the rear A/F sensor 18 become equal from a time T3 onwards. Hence, if switching to the normal air-fuel ratio feedback control is performed at the time T3, highly accurate air-fuel ratio feedback control that is in accordance with the actual situation is enabled. However, it is necessary to consider individual differences between the two sensors. Therefore, in the present embodiment, it is determined that the output values of the two sensors are equal at a time point at which a difference (output difference Vi) between the output values of the two sensors has become less than a compatible value a over a predetermined period (compatible value).

### [Specific Processing in Embodiment 2]

Specific processing of the above described air-fuel ratio feedback control will now be described referring to FIG. 7. FIG. 7 is a flowchart illustrating an air-fuel ratio feedback control routine that is executed by the ECU 20 in Embodiment 2. Note that, it is assumed that the routine illustrated in FIG. 7 is repeatedly executed at regular intervals.

In the routine illustrated in FIG. 7, first, the ECU 20 determines whether or not a precondition is established (step 150), and calculates the above described main FB value using the output value of the rear A/F sensor 18 (step 160). The processing in steps 150 and 160 is the same as the processing in steps 110 and 120 in FIG. 5.

Following step 160, the ECU 20 determines whether or not the output values of the front A/F sensor 16 and rear A/F sensor 18 are equal (step 170). As described above, the ECU 20 determines that the output values of both sensors are equal at a time point at which the output difference Vi has become less than the compatible value a over a fixed period. The processing of the present step is continued until it is determined that the output values of both sensors are equal. When it is determined that the output difference Vi is equal, the ECU 20 executes the normal air-fuel ratio feedback control (step 180). The processing of the present step is the same as the processing in step 140 of FIG. 5.

Thus, according to the routine illustrated in FIG. 7, only sub-feedback control that uses the output value of the rear A/F sensor 18 is executed until it is determined that the output values of the front A/F sensor 16 and rear A/F sensor 18 are equal. Therefore, similar effects to the effects according to the routine illustrated in the above described FIG. 5 can be obtained, and furthermore, it is possible to realize highly accurate air-fuel ratio feedback control that is in accordance with the actual situation.

### DESCRIPTION OF REFERENCE NUMERALS

10 engine
12 exhaust passage
14 catalyst
16 front A/F sensor
18 rear A/F sensor
20 ECU
22 sensor element portion
24 solid electrolyte
26 electrodes
28 diffusion-controlling layer
30 shielding layer
32 heater

1. An air-fuel ratio control device of an internal combustion engine, comprising:
an exhaust purification catalyst that is provided in an exhaust passage of the internal combustion engine;
an upstream-side air-fuel ratio sensor that is provided in the exhaust passage on an upstream side relative to the exhaust purification catalyst, and that continuously outputs a signal that is in accordance with an air-fuel ratio;
a downstream-side air-fuel ratio sensor that is provided in the exhaust passage on a downstream side relative to the exhaust purification catalyst, and that continuously outputs a signal that is in accordance with an air-fuel ratio;
usage permission condition determination means for, at a time of starting the internal combustion engine, after the upstream-side air-fuel ratio sensor and the downstream-side air-fuel ratio sensor are both activated, determining whether or not a predetermined usage permission condition is established with respect to an output of the upstream-side air-fuel ratio sensor; and
startup time air-fuel ratio feedback control execution means for executing air-fuel ratio feedback control using an output of the downstream-side air-fuel ratio sensor until the predetermined usage permission condition is established.

2. The air-fuel ratio control device of an internal combustion engine according to claim 1, wherein main air-fuel ratio feedback control using the output of the upstream-side air-fuel ratio sensor, and sub-air-fuel ratio feedback control using the output of the downstream-side air-fuel ratio sensor is executed after the predetermined usage permission condition is established.

3. The air-fuel ratio control device of an internal combustion engine according to claim 1, wherein the predetermined usage permission condition is whether or not an output difference between the output of the upstream-side air-fuel ratio sensor and the output of the downstream-side air-fuel ratio sensor is less than a predetermined deviation over a set period.

4. The air-fuel ratio control device of an internal combustion engine according to claim 1, wherein the predetermined usage permission condition is whether or not a set period elapses.

5. The air-fuel ratio control device of an internal combustion engine according to claim 1, wherein the startup time air-fuel ratio feedback control execution means prohibits execution of air-fuel ratio feedback control using the output of the upstream-side air-fuel ratio sensor until the predetermined usage permission condition is established.

6. An air-fuel ratio control device of an internal combustion engine, comprising:
an exhaust purification catalyst that is provided in an exhaust passage of the internal combustion engine;
an upstream-side air-fuel ratio sensor that is provided in the exhaust passage on an upstream side relative to the exhaust purification catalyst, and that continuously outputs a signal that is in accordance with an air-fuel ratio;
a downstream-side air-fuel ratio sensor that is provided in the exhaust passage on a downstream side relative to the exhaust purification catalyst, and that continuously outputs a signal that is in accordance with an air-fuel ratio; and
a control device that determines, at a time of starting the internal combustion engine, after the upstream-side air-fuel ratio sensor and the downstream-side air-fuel ratio sensor are both activated, whether or not a predetermined usage permission condition is established with respect to an output of the upstream-side air-fuel ratio sensor and executes air-fuel ratio feedback control using an output of the downstream-side air-fuel ratio sensor until the predetermined usage permission condition is established.

7. The air-fuel ratio control device of an internal combustion engine according to claim 6, wherein, after the predetermined usage permission condition is established, the control device executes main air-fuel ratio feedback control using the output of the upstream-side air-fuel ratio sensor, and sub-air-fuel ratio feedback control using the output of the downstream-side air-fuel ratio sensor.

8. The air-fuel ratio control device of an internal combustion engine according to claim 6, wherein the predetermined usage permission condition is whether or not an output difference between the output of the upstream-side air-fuel ratio sensor and the output of the downstream-side air-fuel ratio sensor is less than a predetermined deviation over a set period.

9. The air-fuel ratio control device of an internal combustion engine according to claim 6, wherein the predetermined usage permission condition is whether or not a set period elapses.

10. The air-fuel ratio control device of an internal combustion engine according to claim 6, wherein the control device prohibits execution of air-fuel ratio feedback control using the output of the upstream-side air-fuel ratio sensor until the predetermined usage permission condition is established.
